(19) United States
(12) Patent Application Publication
(10) Pub. No.: US 2005/0061536 A1
(43) Pub. Date: Mar. 24, 2005

(54) Reduced crosstalk ultrasound cable

(75) Inventor: Timothy L. Proulx, Santa Cruz, CA (US)

Correspondence Address: Siemens Corporation;Intellectual Property Department, 170 Wood Avenue South, Iselln, NJ, 08830, US

(73) Assignee: Siemens Medical Solutions USA, Inc.

(21) Appl. No.: 10/666,375

(22) Filed: Sep. 19, 2003

(51) Int. Cl. H01B 7/18

(52) U.S. Cl. 174/102 R

(57) ABSTRACT

Methods and systems for reducing crosstalk during continuous wave ultrasound data acquisition are provided. A conductive layer electrically shields groups of transmit conductors from groups of receive conductors to reduce noise susceptibility. Mutual coupling during continuous wave Doppler imaging is avoided by providing a shield between or around different groups of conductors. A shielded cable is provided within another cable.

### BACKGROUND

The present invention relates to an ultrasound transducer cable. A cable providing reduced crosstalk during continuous wave Doppler imaging is provided.

During continuous wave Doppler imaging, near continuous sinusoidal or other pulses are applied to a group of transducer elements, such as half of the total number of elements available. Simultaneously, some or all of the remaining elements are used to receive low level echo signals. The signals are provided along channels in a cable connecting the transducer to an ultrasound imaging system. Along the length of the cable, the transmit and received conductors may be capacitively coupled to each other and any other conductors in the region, such as a radio-frequency interference (RFI) shield. Imbalances in the forward and reverse current in the higher voltage transmit operation conductors may inductively couple current to the lower voltage receive operation conductors. The induced current from these crosstalk mechanisms may increase an underlying noise level, reducing imaging quality. Any time-varying changes in the mutual inductance or capacitance may generate frequency side bands on the RF transmit signal that may be detected by the receiver and displayed, resulting in clutter in the Doppler trace. For example, as a cable is repositioned, the transmit and receive conductors may shift in relative positions, resulting in a time varying change in the mutual inductance or capacitance.

To reduce crosstalk between transmit and receive conductors during continuous wave Doppler imaging, individual conductors are shielded from each other, for example, when each conductor is a coaxial cable. The shield for each individual conductor limits the mutual inductance and capacitance. A further reduction in crosstalk between transmit and receive conductors is provided by physically positioning groups of conductors used for transmit in one area and groups of conductors used for receive in a different area. For example, inner conductors within a bundle are used for receive and the outer conductors within a bundle are used for transmit operation. However, some crosstalk between transmit and receive cables may still exist, resulting in undesired noise during continuous wave Doppler imaging.

Crosstalk for continuous wave Doppler imaging in catheter mounted transducers can be reduced by controlling the signals used for receive operation. Radio frequency receive signals are demodulated to baseband audio frequency signals prior to sending the signals along the cable over the conductors. These signals are processed by low frequency circuits that are not affected by any coupling of the RF transmit signals to the receive conductors. As a result, reduced crosstalk is provided, but complicated and expensive circuitry is required at the transducer.

Various approaches have been used to reduce coupling between conductors in non-ultrasound uses, such as uses where only a pair or relatively few number of conductors are needed. For example, crosstalk between conductors is reduced when individual unshielded conductors are electrically separated within multiple hollow cores of a conductive extruded material. As another example, a ribbon cable having multiple twisted pairs of conductors includes a predefined arrangement between adjacent pairs to reduce crosstalk. In another example using a strip line cable, strict control of dielectric thickness between conductors and the ground plane and above the conductors may reduce crosstalk by causing the mutual inductance and capacitance to cancel to zero. For coaxial cables, individual conductors are shielded from each other using a conductive shield layer in each cable.

### BRIEF SUMMARY

The present invention is defined by the following claims, and nothing in this section should be taken as a limitation on those claims. By way of introduction, the preferred embodiments described below include methods and systems for reducing crosstalk during continuous wave ultrasound data acquisition. A conductive layer electrically shields transmit conductors from receive conductors to reduce noise susceptibility. Mutual coupling during continuous wave Doppler imaging is avoided by providing a shield between or around different groups of conductors.

In a first aspect, a cable for reducing crosstalk during ultrasound continuous wave operation is provided. A conductive separation layer separates a first group of ultrasound signal conductors from a second group of ultrasound signal conductors.

In a second aspect, a method for reducing crosstalk during ultrasound continuous wave operation is provided. Ultrasound signals are transmitted along a first group of conductors for a transmit aperture. Ultrasound signals are received along a second group of conductors for a receive aperture. The first group of conductors for the transmit aperture are separated from the second group of conductors for the receive aperture by a conductive shield.

In a third aspect, an ultrasound system for reduced crosstalk in continuous wave ultrasound data acquisition is provided. A first group of conductors is connectable with a respective first group of transducer elements in a transmit aperture. A second group of conductors is connectable with a respective second group of transducer elements in a receive aperture. A conductive shield separates the first group of conductors from the second group.

Further aspects and advantages of the invention are discussed below in conjunction with the preferred embodiments.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 is a graphical representation of one embodiment of a system for reduced crosstalk in continuous wave Doppler ultrasound data acquisition;

FIG. 2 is a flow chart diagram of one embodiment of a method for reducing crosstalk in continuous wave Doppler ultrasound imaging; and

FIGS. 3A-I are cross-section views of different embodiments of a cable for reducing crosstalk during ultrasound continuous wave Doppler operation.

### DETAILED DESCRIPTION OF THE DRAWINGS AND PRESENTLY PREFERRED EMBODIMENTS

As ultrasound systems improve performance for continuous wave Doppler imaging, the amount of acceptable crosstalk in the cable becomes less. Crosstalk is significantly reduced by providing a shield layer separating conductors used for transmit from conductors used for receive operations. The shield layer is provided around groups of conductors. Individual conductors may additionally have shielding, such as coaxial cables. The shielding of different groups may allow the use of unshielded individual conductors for continuous wave Doppler ultrasound imaging as long as coupling between individual conductors within each transmit or receive bundle is acceptable or may be controlled by some method. Unshielded conductors may allow for a greater number of conductors within a same or smaller volume. Increased channel count and/or improved ergonomics may result.

FIG. 1 shows one embodiment of an ultrasound system for reduced crosstalk in continuous wave Doppler ultrasound data acquisition. The system includes a transducer 16, a cable 22, a transmit beamformer 26 and a receive beamformer 28. Additional, different or fewer components may be provided.

The transducer 16 includes a plurality of piezoelectric or capacitive membrane transducer elements in a 1, 2 or other multi-dimensional array. The transducer 16 is part of a hand-held transducer probe in one embodiment, but may be part of a transesophageal, endocavity, catheter or other now known or later developed ultrasound transducer. In one embodiment, the transducer 16 is adapted for medical diagnostic imaging, but may be adapted for materials testing, sonar operation or other uses.

The transmit beamformer 26 includes a plurality of waveform generators for generating transmit waveforms for each element 18 of a transmit aperture of the transducer 16. The transmit beamformer 26 includes phase rotators, delays, amplifiers, digital-to-analog converters or other devices for applying relative delay and apodization profiles across the transmit aperture. The transmit pulses generated are substantially continuous. For example, high cycle counts with or without interruptions for B-mode frame acquisition are provided for continuous wave Doppler imaging.

The receive beamformer 28 includes a plurality of channels for connection with elements 20 in a receive aperture of the transducer 16. The receive beamformer 28 includes phase rotators, delays, amplifiers, analog-to-digital converters, summers and other devices for receiving signals responsive to the transmitted continuous waves in a plurality of channels. The receive beamformer 28 applies the delay and apodization profiles and combines information from a plurality of channels to form a receive beam or receive information representing a focal position. Any of now known or later developed continuous wave receive beamformers may be used.

The cable 22 includes two or more groups of conductors 12, 14 surrounded by a protective cable covering or jacket 24. The conductors 12, 14 are coaxial cables, single extruded wires, ribbons of a plurality of wires separated by a dielectric, flex traces, twisted pairs, bundled wires or other now known or later developed conductor. For example, one group of conductors 12 is within a single or multiple ribbons and another group of conductors 14 is within a different ribbon or group of ribbons. Multiple groups of conductors may be used, such as using one group for receive, and one group for transmit, where the conductors in the other groups are left unused (e.g., floating or grounded).

The conductors 12, 14 are connectable with the elements 18, 20 of the transducer 16 and the transmit and/or receive beamformers 26, 28. For example, the conductors 12, 14 permanently connect with a flexible circuit. Signal traces on the flexible circuit electrically connect the conductors 12, 14 to elements 18, 20 of the transducer 16. As another example, the conductors 12, 14 are releasably connected at the end of the cable 22 to the ultrasound system. A physical and electrical releasable connection separately connects each of the conductors 12, 14 to signal traces or other conductors. The signal traces or conductors within the ultrasound system are routed through a multiplexer, switches or other devices to the transmit beamformer 26 and the receive beamformer 28 as appropriate for operation. For example, different ones of the elements 18, 20 of the transducer 16 are switchably connected to the transmit beamformer 26 and the receive beamformer 28 at different times. As the focal position of a Doppler beam is moved from one side of an image to another side of the image or from one side of a normal to the transducer to another side of the normal to the transducer 16, different conductors 12, 14 are switched between the beamformers 26, 28.

For continuous wave operation, one group of conductors 12 connects with transducer elements 18 for a transmit aperture. Another group of conductors 14 connects with the elements 20 in a receive aperture. As shown, the transmit and receive apertures are on different sides of the transducer 16. In alternative embodiments, one or both of the transmit and receive apertures includes sparsely spaced elements with elements of the other aperture interspersed. The conductors 12 for the transmit aperture provide a transmit bundle of conductors. The conductors 14 for the receive aperture provide a receive bundle of conductors. The transmit bundle of conductors 12 are electrically connected with the transmit beamformer 26. The transmit beamformer 26 generates ultrasound signals provided on the ultrasound signal conductors 12 to the transmit aperture. The receive bundle of conductors 14 are electrically connected with the receive beamformer 28. Electrical signals responsive to acoustic echoes received at the receive aperture are provided as ultrasound signals on the ultrasound signal conductors 14 to the receive beamformer 28. Since the transmit operation occurs at substantially the same time as the receive operation, the conductors 12 of the transmit bundle and the conductors 14 of the receive bundle are different conductors.

The protective cable covering 24 is rubber, plastic, or other now known or later developed covering. The covering provides physical protection to avoid damage to the conductors. The covering 24 alternatively or additionally provides electrical insulation. The covering 24 is around the conductors 12, 14 along a length of the cable 22. The conductors 12, 14 extend beyond the cover 24 at one or both ends.

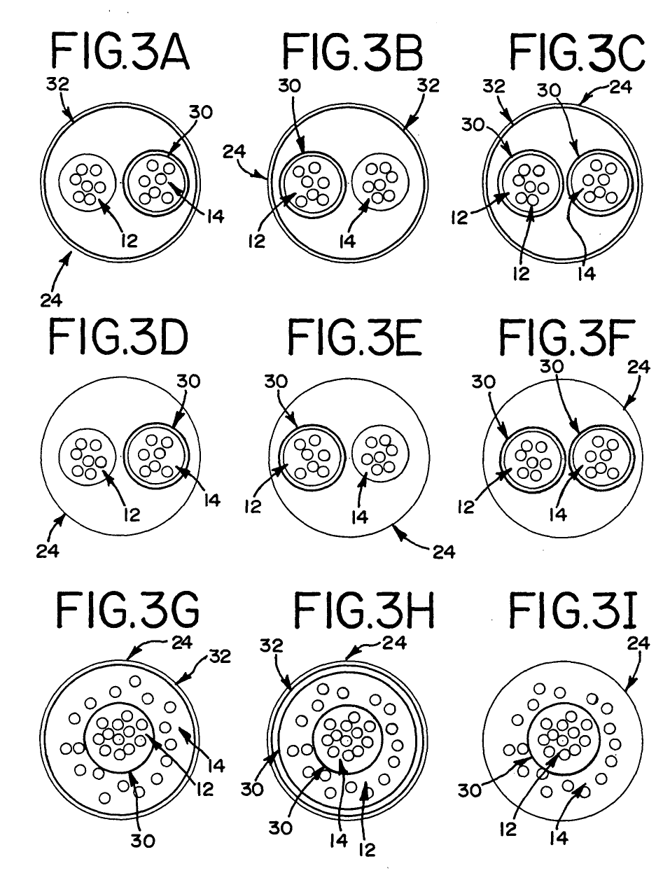

A conductive separation layer 30 is also provided within the covering 24 as shown in FIGS. 3A-I. The conductive separation layer 30 is a braided group of wires, a group of wires that is helically wrapped around the conductors, a ribbon of separate wires and dielectric material, metalized tape, metalized polymer, and/or foil that is wound, wrapped, extruded over, or positioned alongside a plurality of the conductors 12, 14. For example, braided silver plated copper wires are wound or wrapped around a plurality of conductors 12, 14. The conductive separation layer 30 is connected to a constant or ground potential. The conductive separation layer 30 reduces crosstalk within the cable 22 during continuous wave Doppler operation. The conductive separation layer 30 separates the transmit conductors 12 from the receive conductors 14.

FIGS. 3A-I show various alternative embodiments for the groups of conductors 12, 14 and separation by a separation layer 30. FIG. 3A shows a separation layer 30 around receive aperture conductors 14 where the conductors are represented by small circles. The transmit aperture conductors 12 are separated from the receive aperture conductors 14 by the separation layer 30 but are otherwise freely positioned within the covering 24. In alternative embodiments, a dielectric wrap or other non-conductive material is positioned around the transmit aperture conductors 12, such as being wrapped with a tape (e.g., flouropolymer) to protect the conductors from the outer RFI shield 32. FIG. 3B shows the same arrangement of FIG. 3A except the separation layer 30 is positioned around the transmit aperture conductors 12 and not around the receive aperture conductors 14. FIG. 3C shows the same embodiment with separate separation layers 30 wrapped around each of the transmit conductors 12 and the receive conductors 14. As shown in FIGS. 3A through 3C, an additional RFI shield layer 32 connected to the same or different potential as the conductive separation layer provides RFI shielding for all of the conductors 12, 14. The conductors 12, 14 are within the extra shield layer 32. FIGS. 3D through 3F correspond in arrangement to FIGS. 3A through 3C without the RFI shield layer 32.

FIGS. 3G through 3I show yet other alternative embodiments of separating one group of conductors 12 from a different group of conductors 14 by the conductive separation layer 30. As shown in FIG. 3G, the transmit aperture conductors 12 are positioned within a center of the cable and the separation layer 30 is around the transmit bundle. The receive aperture conductors 14 are positioned around the circumference of the conductive separation layer 30. In alternative embodiments, the receive bundle is positioned in a center of the cable and the transmit bundle is positioned around the circumference of the separation layer. An overall RFI conductive shield 32 is positioned around the receive conductors 14 or all of the conductors 12, 14. FIG. 3H shows a separation layer 30 around each of the transmit and receive conductors 12, 14 as well as an RFI shield layer 32 around both of the other conductive separation layers 30. The separation layer 30 is isolated from the RFI shield layer 32 with dielectric material. As a result, two layers of conductive shielding 30, 32 are provided around all of or most of the conductors 12, 14. FIG. 3I shows the transmit bundle separated from the receive conductors 14 by the separation layer 30 without the RFI shield 32.

As shown in FIGS. 3A through 3I, the conductive layer 30 separating one group of conductors 12 from another group of conductors 14 is a tube, such as a fabricated tube of braided wires where the transmit or receive conductors 12, 14 are positioned within the tube and the other conductors 14, 12 are positioned outside of the tube. Additional separation layers or conductors may be provided, such as providing multiple tubes of separation layer 30 around different portions of the transmit bundle or around different portions of the receive bundle. As another example, multiple layers of shielding may be provided for each bundle. Where multiple separation layers 30, 32 are provided, the separation layers 30, 32 are connected to a same ground or grounding potential for different grounding potentials.

In alternative embodiments, one group of conductors is separated from the other group of conductors by a conductive shield positioned between the groups of conductors without being around either of the groups of conductors. For example, a conductive shield extends as a planar sheet down the length of a cable separating one half or other portion of the cable in cross section from the other half or portion of the cable. This layer might be a foil, metalized polymer, or ribbon wires terminated to the same or different potential as the RFI shield 32. One group of conductors is positioned on one side of the conductive shield and the other group of conductors is positioned on the other side of the conductive shield. Where the conductors 12, 14 are coaxial cables, the conductive shield is grounded to a same or different grounding potential as the coaxial cables of the conductors 12, 14.

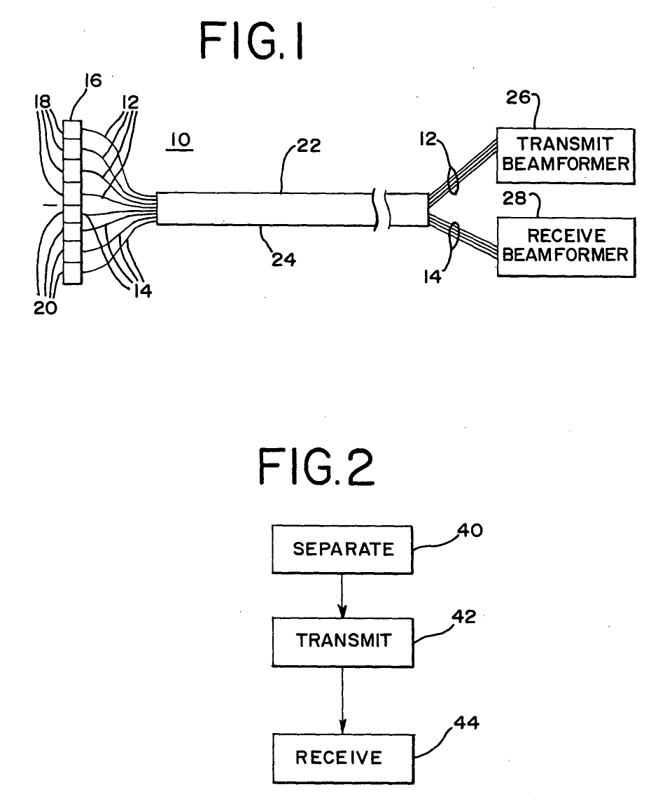

FIG. 2 shows one embodiment of a method for reducing crosstalk during ultrasound continuous wave Doppler operation. The method uses the cable 22 of the system 10 shown in FIGS. 1 and 3, but other cables or systems may be used. Additional, different or fewer acts may be provided in other embodiments.

In act 40, a first group of conductors is separated from a second group of conductors by a conductive shield. The conductive shield is positioned between the two groups of conductors or separate conductive shields are positioned around both of the groups of conductors. The shields may be grounded to a same or different ground potential.

In act 42, ultrasound signals are transmitted over the conductors of one of the groups. The ultrasound signals are for a transmit aperture. For example, the transmit beamformer transmits continuous wave transmit waveforms through the conductors to the transmit aperture of the transducer. The transmit waveforms may have a peak voltage of about 5 volts, but other peak voltages may be used.

In act 44, ultrasound signals are received along the conductors of the other group. The ultrasound signals received are from the receive aperture of the transducer. The signals have a lower voltage or lower peak voltage than the peak voltage of the transmit signals. For example, the receive signals have a peak voltage in the μV to mV range. The conductors used for transmit operation are separated from the conductors used for receive operation by one or more conductive separation layers. The transmit and receive operations of acts 42 and 44 are performed at a same time for continuous wave Doppler imaging.

While the invention has been described above by reference to various embodiments, it should be understood that many changes and modifications can be made without departing from the scope of the invention. For example, any conductive shielding providing physical and electrical separation between groups of conductors used for transmit operations and groups of conductors used for receive operations may be used. The cabling and associated methods disclosed herein may be applied for sonar or other phased array applications. Any types of continuous pulse wave operation for medical diagnostic ultrasound imaging may be provided.

It is therefore intended that the foregoing detailed description be regarded as illustrative rather than limiting, and that it be understood that it is the following claims, including all equivalents, that are intended to define the spirit and the scope of this invention.

1. A cable for reducing crosstalk during ultrasound continuous wave operation, the cable comprising:
a first group of ultrasound signal conductors;
a second group of ultrasound signal conductors, the ultrasound signal conductors of the second group different conductors than the ultrasound signal conductors of the first group; and
a conductive separation layer separating the first group of ultrasound signal conductors from the second group of ultrasound signal conductors.

2. The cable of claim 1 further comprising:
a first plurality of ultrasound transducer elements connected with the first group of ultrasound signal conductors; and
a second plurality of ultrasound transducer elements connected with the second group of ultrasound signal conductors, the first plurality different than the second plurality.

3. The cable of claim 1 further comprising:
a transmit beamformer connectable with the first group of ultrasound signal conductors; and
a receive beamformer connectable with the second group of ultrasound signal conductors.

4. The cable of claim 1 wherein the first group of ultrasound signal conductors comprises a transmit bundle and the second group of ultrasound signal conductors comprises a receive bundle.

5. The cable of claim 1 wherein the first and second groups of ultrasound signal conductors comprise coaxial cables.

6. The cable of claim 1 wherein each of the first and second groups of ultrasound signal conductors comprise at least one ribbon of conductors.

7. The cable of claim 1 wherein the conductive separation layer comprises a braided shield around the first group of ultrasound signal conductors.

8. The cable of claim 1 wherein the conductive separation layer comprises one or more ribbons of grounded conductors around the first group of ultrasound signal conductors.

9. The cable of claim 1 wherein the ultrasound signal conductors are selected from the group of: coaxial cable, ribbon wire, flex trace, twisted pair, bundled wire and combinations thereof.

10. The cable of claim 1 further comprising an additional conductive RFI shield layer around both the first and second groups of ultrasound signal conductors.

11. The cable of claim 1 wherein the conductive separation layer is around the first group of ultrasound signal conductors and the second group of ultrasound signal conductors is positioned around a circumference of the conductive separation layer.

12. A method for reducing crosstalk during ultrasound continuous wave operation, the method comprising:
(a) transmitting ultrasound signals along a first group of conductors for a transmit aperture;
(b) receiving ultrasound signals along a second group of conductors for a receive aperture; and
(c) separating the first group of conductors from the second group of conductors by a conductive shield.

13. The method of claim 12 wherein (a) comprises transmitting at a first peak voltage or higher and (b) comprises receiving the ultrasound signals at a second peak voltage less than the first peak voltage.

14. The method of claim 12 wherein (a) and (b) are performed at a same time.

15. The method of claim 12 wherein (c) comprises positioning the conductive shield around the first group of conductors.

16. The method of claim 12 wherein (c) comprises positioning the conductive shield around the second group of conductors.

17. The method of claim 12 wherein (c) comprises positioning the conductive shield between the two groups of conductors.

18. The method of claim 12 further comprising:
(d) grounding the conductive shield.

19. An ultrasound system for reduced crosstalk in continuous wave Doppler ultrasound data acquisition, the system comprising:
a first group of conductors connectable with a respective first group of transducer elements in a transmit aperture;
a second group of conductors connectable with a respective second group of transducer elements in a receive aperture; and
a conductive shield separating the first group from the second group.

20. The system of claim 19 wherein the conductive shield comprises a tube of braided conductors with one of the first and second groups of conductors within the tube and the other of the second and first groups of conductors outside of the tube.

21. The system of claim 19 further comprising an additional RFI shielding layer around all signal conductors.

22. The system of claim 19 further comprising a protective cable covering around the first and second groups of conductors, the conductive separation layer and the additional RFI shielding layer.

23. The cable of claim 1 wherein the separation layer is selected from the group of: braid, metalized polymer, foil, ribbon wire, served wire and combinations thereof.
